(19) United States
(12) Patent Application Publication
(10) Pub. No.: US 2020/0307245 A1
(43) Pub. Date: Oct. 1, 2020

(54) RECORDING DEVICE

(71) Applicant: SEIKO EPSON CORPORATION, Tokyo (JP)

(72) Inventors: Kazutoshi KASHIWABARA, Shiojiri-shi (JP); Akimasa NOZAWA, Kamiina-gun Tatsuno-Machi (JP); Manato NISHI, Shiojiri-shi (JP); Atsuhiko TAKEUCHI, Matsumoto-shi (JP)

(21) Appl. No.: 16/831,271

(22) Filed: Mar. 26, 2020

(30) Foreign Application Priority Data
Mar. 28, 2019 (JP) 2019-064339

(51) Int. Cl. B41J 2/175; B41J 13/02; B41J 13/22

(52) U.S. Cl. CPC B41J 2/17596; B41J 13/22; B41J 13/02

(57) ABSTRACT

A recording device includes a transport unit, a recording unit configured to move in a first direction and a second direction which is an opposite direction to the first direction, an mounting portion, and a tube including a fixed end fixed at a position downstream of the mounting portion in a liquid supply direction and a movable end movable with respect to the fixed end in the first direction, the movable end being coupled to the recording unit. The tube extends in the first direction from the movable end and extends to the fixed end after being folded back in the second direction. The transport unit includes a transport roller, and a rotation detector configured to detect rotation of the transport roller. When the recording unit is in a retracting region in the first direction, an edge end of a fold back portion of the tube overlaps the rotation detector.

The present application is based on, and claims priority from JP Application Serial Number 2019-064339, filed Mar. 28, 2019, the disclosure of which is hereby incorporated by reference herein in its entirety.

### BACKGROUND

### 1. Technical Field

The present disclosure relates to a recording device including a transport unit configured to transport a medium, a recording unit including a recording head configured to eject a liquid onto the medium and a carriage, and a tube through which the liquid supplied to the recording unit passes.

### 2. Related Art

Typically, a known example of such a type of recording device includes an inkjet-type printer for recording an image and the like onto a medium such as a sheet by ejecting ink (an example of a liquid) from a plurality of nozzles included in a recording head. For example, JP-A-2012-179728 (hereinafter, referred to as Patent Document 1) discloses a recording device including a transport unit configured to transport a medium, a recording head configured to eject a liquid such as ink onto the medium, a carriage mounted with a recording head, the carriage reciprocating, a liquid supply source provided separately of the carriage, and a tube through which a liquid supplied from the liquid supply source to the recording head passes. The carriage reciprocates as a result of a base end of the carriage being slidably attached to a guide unit via sliding units located at both ends of the carriage.

In Patent Document 1, a first end of the tube is coupled to a side of the liquid supply source, and a second end thereof is coupled to the recording head at a leading end of the carriage via a U-shaped inversion portion (an example of a fold back portion). A tube holding member fixed to the carriage is between the sliding units located at the both ends in a width direction of the carriage. The position for fixing the tube to the carriage is at the center in a movement direction of the carriage, and thus, size reduction in a width direction of the recording device is realized.

However, there are following problems in the technology described in Patent Document. That is, when a size reduction in the transport direction intersecting with the width direction is attempted in addition to the size reduction in the width direction, it is difficult for the fold back portion of the tube to allow for a sufficient radius of curvature. This imposes a load on the tube. It is desirable to reduce the size both in a scanning direction and in a transport direction while suppressing a load on the tube.

### SUMMARY

A recording device designed to solve the above-described problems is a recording device including a recording unit including a recording head configured to eject liquid onto a medium to perform recording thereon and a carriage configured to support the recording head and move in a first direction and a second direction which is an opposite direction to the first direction, a transport unit configured to transport the medium in a transport direction intersecting the first direction or the second direction, an mounting portion that is provided downstream of the recording unit in the transport direction and to which a liquid accommodating unit, in which the liquid to be supplied to the recording unit is accommodated, is mounted, and at least one tube having flexibility and including a fixed end fixed at a position downstream of the mounting portion in a liquid supply direction and a movable end configured to move relative to the fixed end in the scanning direction, the movable end being coupled to the recording unit. The at least one tube extends from the movable end in the first direction and extends to the fixed end after being folded back in the second direction, the recording unit is configured to move to a recording region where recording onto the medium is performed and to a retracting region that is outside the recording region in the first direction, the transport unit includes a transport roller configured to rotate to impart a transport force to the medium, and a rotation detector including a rotary scale attached to an edge end of the transport roller in the first direction, and a sensor configured to detect rotation of the transport roller with the rotary scale serving as a detection object, and when the recording unit is in the retracting region, an edge end of a fold back portion of the at least one tube overlaps, at a position in the first direction, with the rotation detector.

### BRIEF DESCRIPTION OF THE DRAWINGS

FIG. 1 is a perspective view illustrating a recording device according to an embodiment.

FIG. 2 is a schematic side sectional view illustrating main parts of the recording device.

FIG. 3 is a schematic plan view illustrating an operation of a recording unit in the recording device.

FIG. 4 is a side view illustrating a state when the recording unit is in a counter-home position.

FIG. 5 is a plan view illustrating a state when the recording unit is in a counter-home position.

FIG. 6 is a schematic side view illustrating the recording unit in the counter-home position.

FIG. 7 is a schematic plan view illustrating the recording unit in the counter-home position.

FIG. 8 is a schematic front view illustrating the recording unit in the counter-home position.

FIG. 9 is a cross-sectional view illustrating a clamp member.

FIG. 10 is a block diagram illustrating an electrical configuration of the recording device.

FIG. 11 is a schematic front view illustrating a recording unit and a tube according to a modification.

### DESCRIPTION OF EXEMPLARY EMBODIMENTS

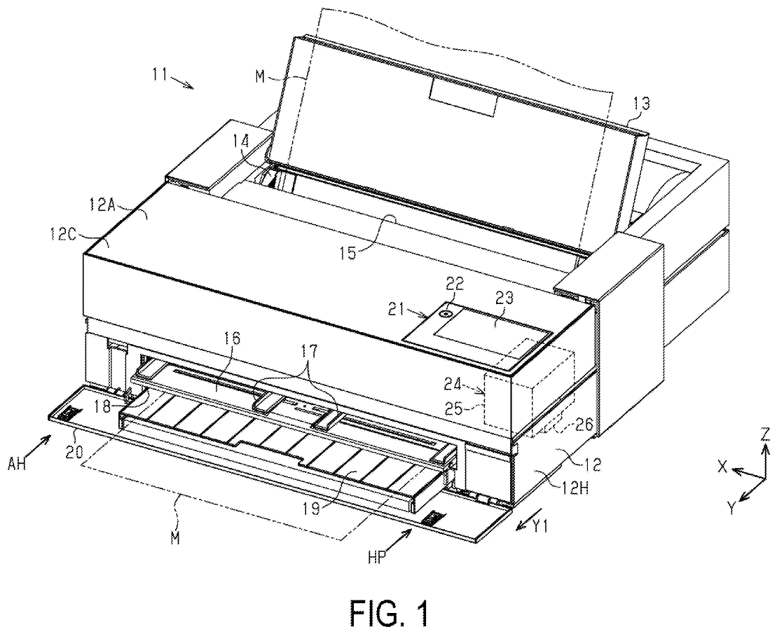

An embodiment of a recording device will be described below with reference to the accompanying figure. In FIG. 1, three virtual axes orthogonal to one another are designated as an X axis, a Y axis, and a Z axis assuming that a recording device 11 is placed on a horizontal surface. The X axis is a virtual axis parallel to a scanning direction of a recording head described below, and the Y axis is a virtual axis parallel to a transport direction Y1 of a medium at the time of printing. Additionally, the Z axis is a virtual axis parallel to a vertical direction. Note that in the recording device 11 illustrated in FIG. 1, a downstream direction of the transport direction Y1 is also referred to as “front” and an upstream direction thereof is also referred to as “rear”.

The recording device 11 illustrated in FIG. 1 is a serial recording-type inkjet printer. The recording device 11 includes a rectangular parallelepiped chassis 12. A first feeding tray 13 in which a user can set a medium M such as a sheet yet to be recorded is provided on an upper surface of the chassis 12. The first feeding tray 13 is of sliding type in which a multi-stage tray is slidably coupled, and is used in an extended state in which the multi-stage tray is slid and extended from a contracted state illustrated in FIG. 1. The first feeding tray 13 includes a pair of edge guides 14 operated by a user when the medium M is positioned in the width direction. The medium M set in the first feeding tray 13 is fed into the chassis 12 through a feeding port 15. As a result of being rotated into a horizontal posture in the contracted state, the first feeding tray 13 is housed to be substantially flush with an upper surface 12A of the chassis 12.

A second feeding tray 16 configured to receive and feed the medium M set from the front is provided at the front part of the chassis 12. The second feeding tray 16 includes a pair of edge guides 17 to be operated when the medium M is positioned in the width direction.

In addition, a discharge port 18 configured to discharge a recorded medium M and a discharge tray 19 on which the recording medium M discharged from the discharge port 18 is loaded are provided at the front part of the chassis 12. The discharge tray 19 is of sliding type in which a multi-stage tray is slidably coupled, and is used in an extended state in which a user slides the multi-stage tray from the contracted state illustrated in FIG. 1. Note that an openable lid 20 is provided on a lower front surface of the chassis 12, and the second feeding tray 16 and the discharge tray 19 housed in the chassis 12 are covered by the closed lid 20.

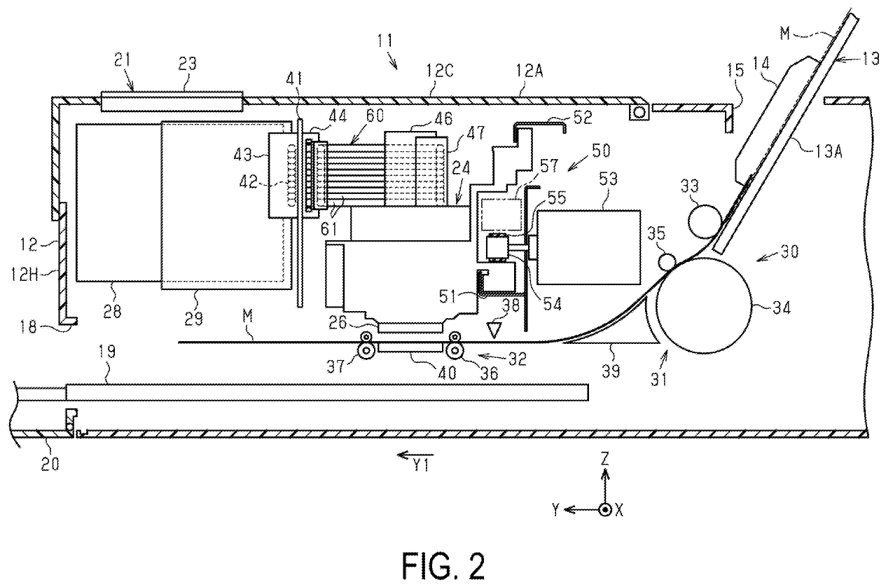

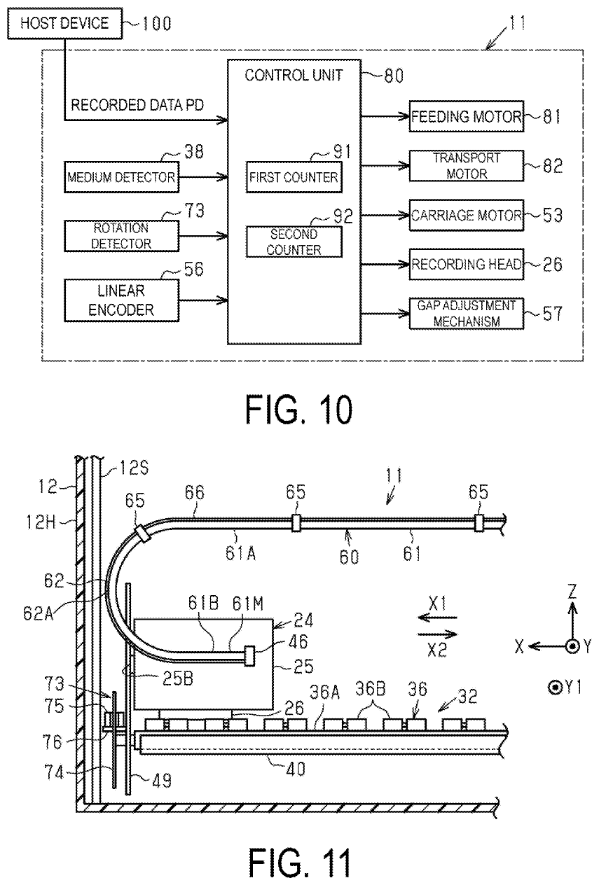

As illustrated in FIG. 1, an operating panel 21 is provided on the upper surface 12A of the chassis 12. The operating panel 21 includes an operation unit 22 such as a power button, and a display unit 23 including a liquid crystal display or the like. A menu, various types of messages, and the like are displayed in the display unit 23. The recording device 11 is communicably coupled to a host device 100 (see FIG. 10). When the recording device 11 receives recorded data from the host device 100, the medium M set in a specified one of the plurality of feeding trays 13 and 16 is fed by a feeding unit 31 (see FIG. 2), and an image based on the recorded data is recorded on the fed medium M.

In the chassis 12, a recording unit 24 is provided as an example of a recording unit configured to perform recording by ejecting a liquid such as ink onto the medium M. The recording unit 24 includes a recording head 26 configured to eject a liquid onto the medium M, and a carriage 25 configured to support the recording head 26 and move in a scanning direction X along the X axis. The recording device 11 records an image or a text on the medium M by alternately performing a recording operation in which the recording head 26 ejects liquid droplets to perform recording for one pass while the recording unit 24 moves along the X axis, and a transport operation in which the medium M is transported to a next recording position. Note that the recording unit 24 reciprocates, and thus, the scanning direction X includes a first direction X1 and a second direction X2.

As illustrated in FIG. 1, the chassis 12 includes a rectangular box-shaped housing 12H of which the upper part made of synthetic resin, for example, opens, and a cover 12C made of a synthetic resin, the cover 12C being configured to open and close the upper opening of the housing 12H. When maintenance works including a jam eliminating work performed when the medium M is jammed and a replacing work for replacing a liquid accommodator 28 described later are performed, the user opens the cover 12C.

FIG. 2 illustrates a schematic side sectional view illustrating the recording device 11. Note that in FIG. 2, the second feeding tray 16 is omitted. As illustrated in FIG. 2, a transport mechanism 30 configured to transport the medium M set in the feeding trays 13 and 16 is provided in the chassis 12. The transport mechanism 30 includes the feeding unit 31 configured to feed the medium M, and a transport unit 32 configured to receive the medium M fed from the feeding unit 31 and transport the medium M in the transport direction Y1 intersecting with the scanning direction X. The feeding unit 31 includes the feeding tray 13, a feeding roller 33 configured to feed a plurality of media M, one by one, set in the feeding tray 13, and an intermediate roller 34 and a driven roller 35 configured to nip and feed the medium M fed by the feeding roller 33. The intermediate roller 34 and the driven roller 35 rotate while nipping the medium M to feed the medium M to a recording region where the recording head 26 performs recording. The feeding tray 13 includes a multi-stage tray portion 13A on which the medium M is placed and a pair of edge guides 14. The feeding roller 33 and the intermediate roller 34 are rotated by a driving force of a feeding motor 81 (see FIG. 10).

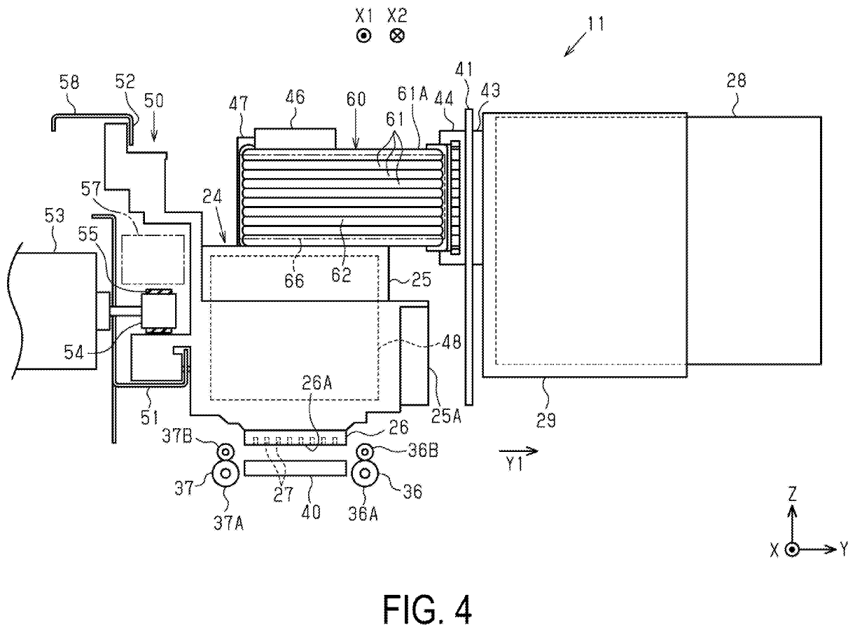

As illustrated in FIG. 2, the transport unit 32 includes two roller pairs 36 and 37. That is, the transport unit 32 includes the transport roller pair 36 and the discharge roller pair 37 located downstream of the transport roller pair 36 in the transport direction Y1. A support 40 configured to support a portion of the medium M where the liquid is ejected by the recording head 26 is disposed between the two roller pairs 36 and 37 in the transport direction Y1. The recording head 26 includes a nozzle face 26A being a face facing the support 40, and a plurality of nozzles 27 (see FIG. 4) open on the nozzle face 26A. The support 40 is formed of an elongated plate-like member extending along a movement path of the recording head 26. The recording head 26 ejects the liquid onto a portion of the medium M supported by the support 40, and records an image and a text on the medium M.

A medium detector 38 configured to detect presence or absence of the medium M is disposed at a position downstream of the feeding unit 31 and upstream of the transport roller pair 36, on a transport path along which the transport mechanism 30 transports the medium M. In addition, a guide member 39 forming a portion of the transport path, the guide member 39 being configured to guide the medium M is disposed at a position between the intermediate roller 34 and the transport roller pair 36 in the transport path. When both sides of the medium M are printed, a first side of the medium M is recorded, and then, the discharge roller pair 37 is reversed, and thus, the medium M is reversely transported toward the upstream in the transport direction Y1, the medium M is inversed along an outer periphery of the intermediate roller 34 by way of a path below the guide member 39, and the medium M is fed again toward the recording region with a second side being a side opposite to the first side of the medium M, facing upward. Subsequently, the medium M of which the both sides are recorded is discharged from the discharge port 18. The medium M set in the second feeding tray 16 is fed to the recording region PA along the same inversion path as when the medium M is fed again while the both sides of the medium M are recorded.

Note that the feeding unit 31 is not limited to a system employing the feeding trays 13 and 16, and may employ a cassette feeding system including a cassette detachably housed in a lower part of the chassis 12 and a pickup roller configured to feed out the first sheet of media M accommodated in the cassette. In addition, the feeding unit 31 may employ a roll-type feeding system where a feeding mechanism capable of rotatably mounting roll paper is provided at a rear portion of the chassis 12 and recording is performed on a medium M fed out from the roll paper. In this case, the recording device 11 may include a cutter mechanism configured to cut the long recorded medium M into a predetermined size, near the discharge port 18 in the chassis 12.

As illustrated in FIG. 2, the recording unit 24 is supported by a movement mechanism 50 to be movable along the X axis. The movement mechanism 50 includes a pair of upper and lower rail members 51 and 52 disposed in the chassis 12, a carriage motor 53 being a drive source of the carriage 25 being guided by the pair of rail members 51 and 52 to move along the X axis, and a pair of pulleys 54 and a timing belt 55 configured to transmit power of the carriage motor 53 to the carriage 25. The carriage 25 is supported by the pair of upper and lower rail members 51 and 52 in the chassis 12 and is movably guided along the X axis. The carriage motor 53 is disposed at one end and at a rear position of the movement path of the carriage 25. The pair of pulleys 54 located at a predetermined distance in the direction along the X axis, and the endless timing belt 55 extending along the X axis while being wound around the pair of pulleys 54 are provided at the rear position of the movement path of the carriage 25. One of the pair of pulleys 54 is coupled to an output shaft of the carriage motor 53. When the carriage motor 53 is driven forward and backward, the recording unit 24 reciprocates along the X axis. That is, the recording unit 24 reciprocates in the first direction X1 being one direction along the X axis and the second direction X2 being a direction opposite to the first direction X1.

The recording device 11 includes a gap adjustment mechanism 57 configured adjust a gap between the recording head 26 and the support 40. The gap adjustment mechanism 57 is electrically or mechanically driven, and adjusts a gap between the recording head 26 and the medium M by adjusting a height position of the recording head 26 being a position of the recording head 26 in the Z direction along the Z axis in accordance with a medium type being a type of medium M. Behind the carriage 25, a linear encoder 56 (see FIG. 10) extends along the movement path of the carriage 25. The linear encoder 56 includes a linear scale tensioned along the movement direction of the carriage 25 and a sensor fixed to a back surface of the carriage 25, the sensor being capable of optically reading the linear scale (both components are not illustrated). Note that the rail members 51 and 52 are formed of a part of a main frame 58 made of metal that extends along the X axis in the chassis 12.

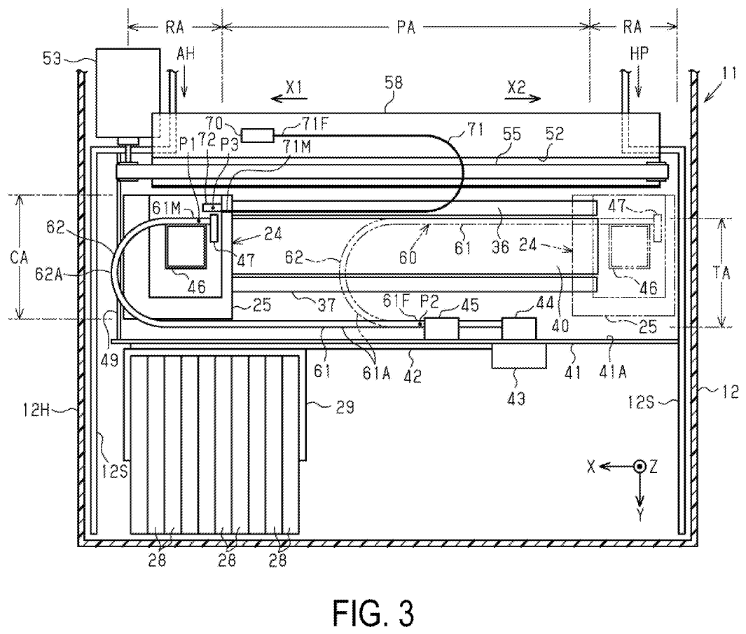

As illustrated in FIG. 2 and FIG. 3, in the chassis 12, an mounting portion 29 that can be mounted with a liquid accommodator 28, which is an example of a liquid accommodating unit in which the liquid supplied to the recording unit 24 is accommodated, is provided downstream of the recording unit 24 in the transport direction Y1. The mounting portion 29 is disposed at a front part inside the chassis 12 and at a height position above the discharge port 18. The liquid accommodator 28 including a plurality of ink cartridges or the like is detachably mounted in the mounting portion 29. Note that the example employs an off-carriage type in which the liquid accommodator 28 is disposed at a position different from that of the carriage 25.

The recording device 11 may include an unillustrated pump for supplying the liquid from the liquid accommodator 28 mounted in the mounting portion 29. In this case, the pump is driven to supply the liquid from the liquid accommodator 28 through a flow path 42 and a tube 61 to the recording head 26 of the recording unit 24. The tube 61 is a flexible member having a tube shape. The tube 61 is made of, for example, a synthetic resin material. The tube 61 includes a plurality of the tubes 61 provided side-by-side in the Z direction intersecting the two directions, that is, the scanning direction X and the transport direction Y1. The plurality of tubes 61 form a band-like tube bundle 60 integrally coupled in one row in the Z direction being a direction in which the plurality of tubes 61 are aligned.

As illustrated in FIG. 3, the recording unit 24 moves between a home position HP indicated by a double dot chain line in FIG. 3, that is, a standby position at which the recording unit 24 stands by when recording is not performed and a counter-home position AH indicated by a solid line in FIG. 3, that is, an end position on a side opposite to a side of the home position HP in the X axis. A maximum range where the recording unit 24 ejects liquid droplets from the nozzles 27 (see FIG. 4) in this movement region to perform recording on the medium M defines a recording region PA. Regions on both sides outside the recording region PA in the X direction define retracting regions RA. The recording unit 24 is movable in the scanning direction X to the recording region PA where recording is performed on the medium M and to the retracting region RA outside the recording region PA in the first direction X1. In the example, one of the retracting regions RA is the home position HP and the other of the retracting regions RA is the counter-home position AH. That is, when being in the retracting region RA in the first direction X1 on the movement path, the recording unit 24 is located in the counter-home position AH, and when being in the retracting region RA in the second direction X2, the recording unit 24 is located in the home position HP.

As illustrated in FIG. 3, the liquid accommodator 28 includes a plurality of the liquid accommodators 28, and the liquid accommodators 28 aligned in the X direction can be mounted in the mounting portion 29. The liquid accommodators 28 include supply ports (not illustrated) configured to supply liquid. A plurality of supply needles (not illustrated) configured to be coupled to the supply ports of the liquid accommodators 28 are provided at a plurality of mounting locations in the mounting portion 29. When the liquid accommodators 28 are mounted in the mounting portion 29, the supply needles are inserted into the supply ports. This allows the liquid in the liquid accommodators 28 to be supplied to the recording unit 24 via the mounting portion 29.

As illustrated in FIG. 3, in the chassis 12, the recording unit 24 reciprocates in the first direction X1 and the second direction X2, which are two directions opposite each other along the X axis. The mounting portion 29 is arranged in an arrangement region close to the counter-home position AH in the chassis 12. As illustrated in FIG. 3, a front frame 41 being an example of a support portion to which the mounting portion 29 is attached is vertically provided in the chassis 12. A plurality of flow paths 42 extend from the mounting portion 29 along the front frame in the second direction X2, and a downstream end of each of the flow paths 42 in a liquid supply direction is coupled to a buffer 43 fixed to a front face of the front frame 41. The plurality of flow paths 42 are arranged side by side in the Z direction. The buffer 43 includes a liquid storage unit configured to temporarily store a predetermined amount of liquid for each liquid accommodator 28.

A plurality of liquid storage units included in the buffer 43 and a first joint members 44 configured to communicate through the plurality of flow paths (not illustrated) are provided at an opposite side of the buffer 43 with the front frame 41 interposed therebetween. The first joint member 44 includes a plurality of tubes (not illustrated) configured to connect ten tubes 61 with a flow path therein, for example. One ends of the ten tubes 61 are respectively coupled to the tubes of the first joint member 44. Furthermore, a portion of each of the tubes 61 extending from the first joint member 44 by a predetermined length is fixed by the fixing member 45 to a face 41A of the front frame 41. In the example, the portion of the tube 61 fixed by the fixing member 45 serves as a fixed end 61F of the tube 61. Note that the face 41A of the front frame 41 is orthogonal to the Y axis.

In the chassis 12, a position at which the recording unit 24 is at one end illustrated by a double dot chain line in FIG. 2 on the movement path is the home position HP. A maintenance device (not illustrated) is disposed directly below the recording unit 24 when the recording unit 24 is in the home position HP. The recording unit 24 stands by in the home position HP during the standby when the recording unit 24 performs no recording on the medium M. In the standby position, the nozzle face 26A where the nozzles 27 of the recording head 26 (see FIG. 4) open is capped by a cap provided in the maintenance device to surround the nozzles 27.

Next, a peripheral configuration of the recording unit 24 will be described with reference to FIG. 3 and FIG. 4.

As illustrated in FIG. 4, the transport roller pair 36 is disposed at a position upstream of the support 40 in the transport direction Y1. The transport roller pair 36 includes a transport roller 36A and a driven roller 36B rotating to follow the transport roller 36A. In addition, the discharge roller pair 37 is disposed at a position downstream of the support 40 in the transport direction Y1. The discharge roller pair 37 includes a discharge roller 37A and a driven roller 37B rotating to follow the discharge roller 37A. The driven roller 37B includes a toothed roller, for example.

In FIG. 3, the recording unit 24 illustrated by the double dot chain line is in the home position HP (home position) where the recording unit 24 stands by during a non-recording time where the recording unit 24 performs no recording on the medium M. The home position HP is at one end outside the support 40 in the direction along the X axis. The recording unit 24 moves toward the support 40 from the home position HP and reciprocates in the first direction X1 and the second direction X2 intersecting the transport direction Y1 within the recording region PA to perform recording on the medium M. When the carriage motor 53 is driven forward, the recording unit 24 moves forward in the first direction X1, and when the carriage motor 53 is driven backward, the recording unit 24 moves backward in the second direction X2.

As illustrated in FIG. 3, the tube 61 extends in the first direction X1 being one direction along the X axis from a movable end 61M, is folded back in the second direction X2 opposite to the first direction X1, and extends to the fixed end 61F. The movable end 61M of each of the tubes 61 is coupled to the carriage 25 at a first coupling position P1. The fixed end 61F of each of the tubes 61 is coupled to the front frame 41 at a second coupling position P2. The front frame 41 includes the face 41A intersecting the transport direction Y1, and the face 41A supports the second coupling position P2 of the tube 61.

Here, in the embodiment, the first direction X1 is a direction where the recording unit 24 moves from the home position HP toward the counter-home position AH when the recording unit 24 reciprocates in FIG. 3. The second direction X2 is a direction from the counter-home position AH toward the home position HP. The plurality of tubes 61 define a U-shaped curved part 62 folded back to follow displacement of the medium M into the transport direction Y1. Thus, the plurality of tubes 61 define the curved part 62 curving horizontally to follow displacement in the transport direction Y1. The tube 61 includes two straight-line parts at both sides with the curved part 62 interposed therebetween, and the straight-line parts extend along the X axis and are substantially parallel to each other. A length of each of the two straight-line parts changes when a position where the curved part 62 is formed changes as the recording unit 24 moves. The plurality of tubes 61 included in the tube bundle 60 are arranged in one row so as to overlap in the Z direction. In the embodiment, the first direction X1 and the second direction X2 being directions along the X axis are the scanning direction being a movement direction in which the recording unit 24 reciprocates. In addition, in the embodiment, an alignment direction in which the plurality of tubes 61 included in the tube bundle 60 are aligned is a direction along the Z axis.

As illustrated in FIG. 3, the curved part 62 moves as the recording unit 24 moves so that as the recording unit 24 moves, a position at which the curved part 62 is defined in the tube 61 moves approximately half as much as the carriage moves.

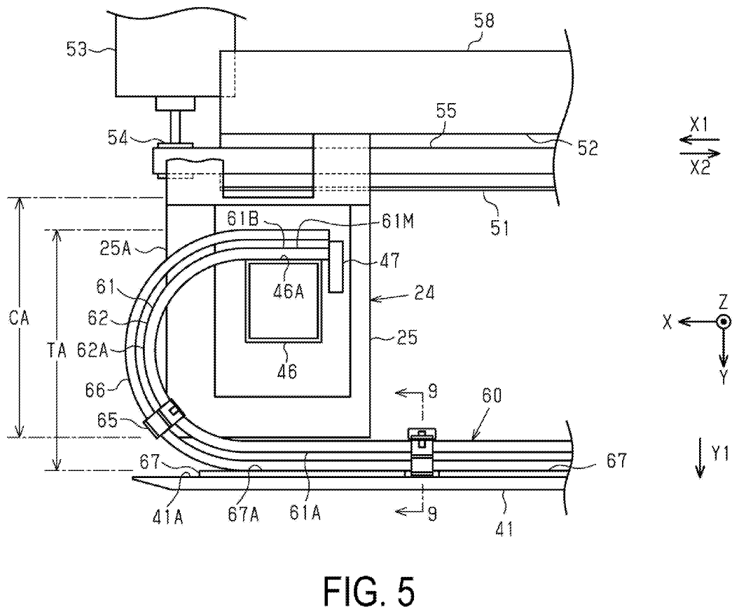

As illustrated in FIG. 4 and FIG. 5, the carriage 25 includes a carriage main body 25A configured to support the recording head 26, a rectangular cylindrical support tube 46 protruding upward from the upper side of the carriage body 25A, and a second joint member 47 to which the movable end 61M of the tube 61 is coupled. As illustrated in FIG. 5, the movable end 61M of the tube 61 is guided along a guide face 46A formed of one side of the support tube 46 to define a straight-line part 61B extending in parallel along the X axis. More specifically, the support tube 46 is at approximately the same height as the tube bundle 60 in which the plurality of tubes 61 are integrally formed in a band shape. The other end on a side opposite to a side of the fixed end 61F in the tube 61 is guided by the guide face 46A being one side of the support tube 46 on the recording unit 24, and is then coupled to the second joint member 47 provided on the carriage 25. In the example, the other ends including the ends of the tubes 61 coupled to the second joint member 47 and the straight-line part 61B of the tube 61 guided by the guide face 46A serve as the movable ends 61M.

Here, a reason why the straight-line part 61B is formed along the X axis such that the other end of the tube bundle 60 is along the guide face 46A of the support tube 46 is to suppress a vertical movement of the tube 61 when the carriage 25 is driven. This also prevents a case where deformation in the curved part 62 reaches a coupling part with the second joint member 47, and a force in a direction different from the direction along the X axis is applied to the coupling part, and as a result, excessive stress is applied to the movable end 61M of the tube 61, and further prevents the tube 61 from being removed from the second joint member 47, for example. With the straight-line part 61B, the curved part 62 is shifted, by the length of the straight-line part 61B, toward the first direction X1 with respect to the carriage 25. Thus, when the recording unit 24 is in the retracting region RA in the first direction X1, that is, in the counter-home position AH, a part of the curved part 62 protrudes outward the carriage 25 in the first direction X1.

The fold back portion of the tube 61 is the curved part 62 curving in a semi-circular arc. Here, if a radius of curvature of the curved part 62 is too small, the tube 61 may be forcibly bent and the tube 61 may receive a load, possibly resulting in a reduced durable time of the tube 61. On the contrary, if the radius of curvature of the curved part 62 is too large, a tube movement region TA in the chassis 12 required to route the tube 61 in the transport direction Y1 increases. The tube movement region TA requires approximately twice the radius of curvature of the curved part 62 in the transport direction Y1.

As illustrated in FIG. 3, when viewed from the direction along the Z axis, a center portion of the carriage 25 is located, in the transport direction Y1, between the first coupling position P1, which is a position where the plurality of tubes 61 are coupled to the carriage 25, and the second coupling position P2, which is a position where the plurality of tubes 61 are mounted to the mounting portion 29.

As illustrated in FIG. 3, in the embodiment, in the transport direction Y1, the tube movement region TA overlaps with at least half of a carriage movement region CA being a movement region of the carriage 25. In other words, the movable end 61M of the tube 61 is coupled to the second joint member 47 while being guided by the guide face 46A being one side opposite the fixed ends 61F, with respect to the support tube 46 protruding upward from the center portion of the carriage 25 in the transport direction Y1. Thus, compared to a configuration in which the portion where the tube movement region TA and the carriage movement region CA overlap in the transport direction Y1 is less than 20% the carriage movement region CA, the dimension of the chassis 12 in the transport direction Y1 can be shortened. Thus, as the portion where the carriage movement region CA and the tube movement region TA overlap increases in the transport direction Y1, the dimension of the chassis 12 in the transport direction Y1, that is, a depth of the recording device 11 can be shortened. In the embodiment, at least half of the tube movement region TA overlaps with the carriage movement region CA in the transport direction Y1. In particular, in the example illustrated in FIG. 3, at least 80% of the tube movement region TA overlaps with the carriage movement region CA in the transport direction Y1.

In the example, an area above the carriage 25 is utilized for a routing space for routing the tube bundle 60 coupled to the first coupling position P1. As a result, it is possible to ensure a large portion where the carriage movement region CA and the tube movement region TA overlap in the transport direction Y1. Specifically, the center portion of the carriage 25 is located, in the Y axis, between the first coupling position P1, which is the position of the movable ends 61M where the plurality of tubes 61 are coupled to the carriage 25, and the second coupling position P2, which is the position of the fixed ends 61F of the plurality of tubes 61. In other words, the support tube 46 disposed to protrude in the center portion of the carriage 25 in the transport direction Y1 between the first coupling position P1, which is the coupling position of the movable ends 61M, and the second coupling position P2, which is the coupling position of the fixed ends 61F.

As illustrated in FIG. 3, the recording device 11 includes a control board 70 configured to control the recording head 26, and a cable 71 configured to couple the recording head 26 to the control board 70. In the transport direction Y1, the control board 70 is provided at a side opposite to a side of the mounting portion 29 with respect to the movement path of the carriage 25. The cable 71 extends from the recording unit 24 in the second direction X2, and is folded back in the first direction X1 to be coupled to the control board 70. A movable end 71M of the cable 71 is fixed by a fixing member 72 to the recording unit 24. A fixed end 71F of the cable 71 is fixed at a predetermined position of the main frame 58. The control board 70 is assembled at a predetermined position of the main frame 58, for example.

A third coupling position P3 being a position where the cable 71 is coupled to the carriage 25 is on the same side as the first coupling position P1 with respect to the center portion of the carriage 25 in the transport direction Y1. The support tube 46 is disposed on the upper side of the carriage 25. In the carriage 25, a liquid supply unit 48 configured to supply the liquid to the recording head 26 is disposed below a position where the tube bundle 60 is disposed. For example, when the recording head 26 has N nozzle rows, the number of tubes 61 is N.

For example, in a typical configuration where the number of nozzle rows is N and the number of tubes 61 is N+1, the number N of nozzle rows is smaller by one than the number N+1 of tubes 61, and therefore, the two tubes 61 are switched to be used for one nozzle row. In this case, types of liquids flowing through the two tubes 61 differ, and thus, when the tubes 61 are switched, the liquids needs to be changed in a flow path up to the nozzle downstream of the tube 61, and a typical ink supply unit includes a liquid change motor as a drive source for changing the liquids. A large liquid supply unit including the liquid change motor is disposed above the carriage 25. In this case, there is a need that the curved part 62 of the tube 61 is folded at a large radius of curvature in order to avoid the liquid supply unit disposed above the carriage 25.

On the other hand, in the embodiment, the number of tubes 61 included in the tube bundle 60 and the number of nozzle rows are the same, so there is no need to change the liquids. Thus, the liquid change motor can be eliminated, and the liquid supply unit 48 is disposed below the carriage 25. That is, as described above, in the carriage 25, the liquid supply unit 48 is disposed below a position where the tube bundle 60 is disposed. Furthermore, the support tube 46 configured to support the band-like tube bundle 60 protrudes on the upper side of the carriage 25.

In the example illustrated in FIG. 5, the support tube 46 is disposed in the center portion of the carriage 25 in the transport direction Y1. Thus, the movable end 61M of the tube bundle 60 is upstream of a center position of the carriage 25 in the transport direction Y1.

Thus, in the transport direction Y1, the tube movement region TA overlaps at least half of the carriage movement region CA. In the example, when the recording unit 24 is in the counter-home position AH illustrated in FIG. 5, the movable end 61M and the curved part 62 of the tube 61 are approximately above the carriage body 25A. As a result, the radius of curvature of the curved part 62 can be equal to or less than a predetermined range, where the curved part 62 is formed when the tube 61 is folded back while the curved part is formed from the straight-line part 61B formed by guiding the tube 61 along the guide face 46A running along the X axis of the support tube 46.

Note that in the embodiment, one band-like tube bundle 60 is formed by arraying the N tubes 61 to be formed as a single-piece. The tube bundle 60 includes a fixed end formed as a result of the fixed ends 61F of the plurality of tubes 61 being bundled and a movable end formed as a result of the movable ends 61M of the plurality of tubes 61 being bundled. Note that the number N of tubes 61 is “ten” in the example, but may be at least “two” other than “ten” or may be “one”.

As illustrated in FIG. 5, a plurality of clamp members 65 are attached to the plurality of tubes 61 at intervals in a longitudinal direction of the plurality of tubes 61. A movable unit 61A used to form the curved part 62 serving as the fold back portion of the tube 61, is supported by a band-like thin plate 66 made of metal. The movable unit 61A is a displaceable portion forming a portion downstream of the fixed end 61F in the liquid supply direction in a longitudinal direction of the tube bundle 60, and is a portion between the curved part 62 illustrated by the double dot chain line in FIG. 3 and the curved part 62 indicated by a solid line in FIG. 3. The portion includes both the curved parts 62. The band-like thin plate 66 has a predetermined width dimension longer than a width of the tube bundle 60 in the Z direction in a state where the thin plate 66 supports the tube bundle 60, and has an entire length longer than a length of the movable unit 61A. In the example, the tube bundle 60 is supported by the band-like thin plate 66 made of metal over a region which includes and is longer than the movable unit 61A. As illustrated in FIG. 5, the band-like thin plate 66 is mounted to cover a side surface serving as an outer peripheral surface of the curved part 62 in the movable unit 61A. An example of the metal material of the band-like thin plate 66 may include SUS. Other examples of metal material of the band-like thin plate 66 may include iron, stainless steel, and aluminum.

As illustrated in FIG. 5, the band-like thin plate 66 and the movable unit 61A of the tube bundle 60 are clamped by the plurality of clamp members 65 at intervals along the longitudinal direction. The clamp member 65 is attached to a position away from the outermost part of the curved part 62 in the first direction X1 when the recording unit 24 is in the counter-home position AH so as not to affect the width dimension of the recording device 11. In addition, the clamp member 65 clamps the tube 61 and the band-like thin plate 66 which are spaced apart.

The movable unit 61A of the tube bundle 60 is supported by the band-like thin plate 66 made of metal, and thus, the movable unit 61A of the tube bundle 60 is suppressed from sagging due to its weight. For example, when the recording unit 24 is in the home position HP illustrated by the double dot chain line in FIG. 3, even if the curved part 62 is away from the recording unit 24, the movable unit 61A including the curved part 62 is supported by the band-like thin plate 66 made of metal, and thus, the tube bundle 60 is suppressed from sagging due to its weight. At a normal time other than a recording time, the recording unit 24 is disposed in the home position HP, and when the recording unit 24 is in the home position HP, the tube bundle 60 is suppressed from sagging due to its weight, and therefore, the sagging tendency of the tube bundle 60 is prevented. Further, for example, when the recording unit 24 is in the counter-home position AH illustrated in FIG. 3 and FIG. 5, the curved part 62 is closest to the recording unit 24 and is less likely to sag, and the movable unit 61A including the curved part 62 is supported by the band-like thin plate 66 made of metal, and thus, the sagging of the curved part 62 is further prevented. For example, when the recording unit 24 is in the counter-home position AH, the curved part 62 is prevented from sagging to contact with other elements in the chassis 12.

In addition, as illustrated in FIG. 5, on the face 41A (rear face) at a side of the front frame 41 to which the fixed end 61F of the tube 61 is coupled, an abutting portion 67 is provided at a position where the band-like thin plate 66 abuts against the abutting portion 67 but the clamp member 65 does not abut against the abutting portion 67. A plurality of the abutting portions 67 are provided and arrayed on the face 41A of the front frame 41 at intervals in the X direction. When the tube bundle 60 is disposed in parallel along the rear face of the front frame 41, and the clamp member 65 is disposed at a position corresponding to an interval between the abutting portions 67, the clamp member 65 enters a recessed portion between the abutting portions 67, and the band-like thin plate 66 held by the clamp member 65 abuts against a flat abutment surface 67A of the abutting portion 67. That is, the abutting portion 67 is disposed at a site against which the band-like thin plate 66 abuts so that a portion corresponding to the clamp member 65 is the interval to prevent the clamp member 65 from abutting against the abutting portion 67. A protrusion length of the abutting portion 67 toward upstream in the transport direction Y1 from the face 41A of the front frame 41, that is, a thickness of the abutting portion 67, is larger than a length by which the clamp member 65 protrudes outward from the tube 61. Thus, the clamp member 65 does not contact the front frame 41. The abutting portion 67 is formed by bending a synthetic resin sheet into a rectangular cylindrical shape or a U-shape, and deforms relatively easily when faces of the abutting portion 67 receive a force. As a result, the impact generated when the band-like thin plate 66 abuts against the abutting portion 67 can be mitigated.

For example, in a configuration without the abutting portion 67, in a process of the recording unit 24 moving in the second direction X2, the clamp member 65 collides with the rear face of the front frame 41, which causes the tube bundle 60 to vibrate. In the embodiment, in a process of the recording unit 24 moving in the first direction X1, the band-like thin plate 66 abuts against the abutting portion 67 while avoiding the collision of the clamp member 65 against the rear face of the front frame 41, which prevents the tube bundle 60 from vibrating.

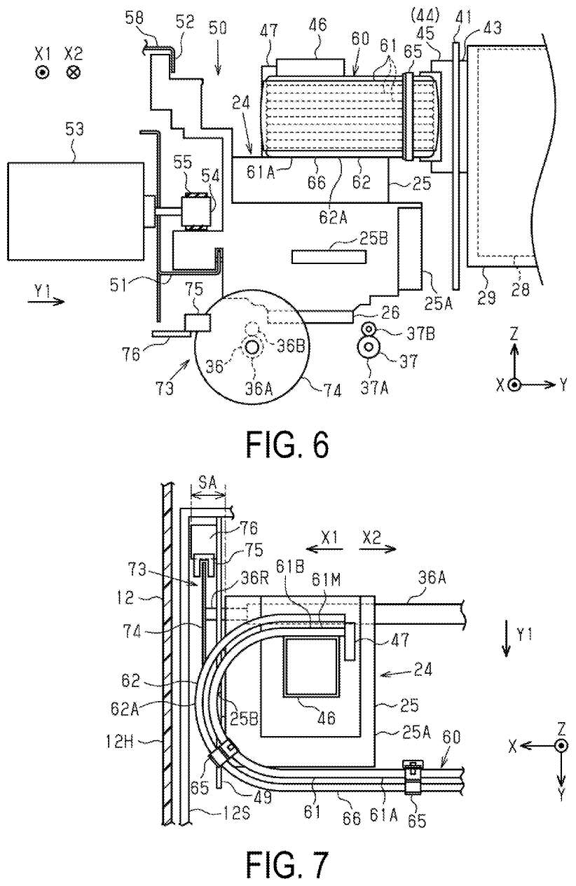

Next, with reference to FIG. 6 to FIG. 8, a peripheral configuration of the recording unit 24 will be described when the recording unit 24 is in the counter-home position AH. Note that in FIG. 6, a side plate frame 49 is omitted which is configured to receive a stopper 25B provided on a side surface of the carriage 25 when the carriage 25 is in the counter-home position AH.

As illustrated in FIG. 6 to FIG. 8, the transport unit 32 includes the transport roller 36A configured to rotate to impart a transport force to the medium M and a rotation detector 73 configured to detect the rotation of the transport roller 36A. The rotation detector 73 includes a rotary scale 74 attached to an edge end of the transport roller 36A in the first direction X1, and a sensor 75 configured to detect the rotation of the transport roller 36A where the rotary scale 74 is to be detected. The rotary scale 74 is formed of a resin plate through which light does not transmit, has a circular plate shape, and is provided with a plurality of slits (through-holes) at predetermined intervals around the circular plate. The sensor 75 is disposed so that a light-emitting unit and a light-receiving unit face each other with the rotary scale 74 interposed therebetween. Then, when the slits reach a portion where the light-emitting unit and the light-receiving unit face each other, light passing through the slits changes into a pulse signal, and the sensor 75 detects the pulse signal. That is, the rotation detector 73 is of optical type.

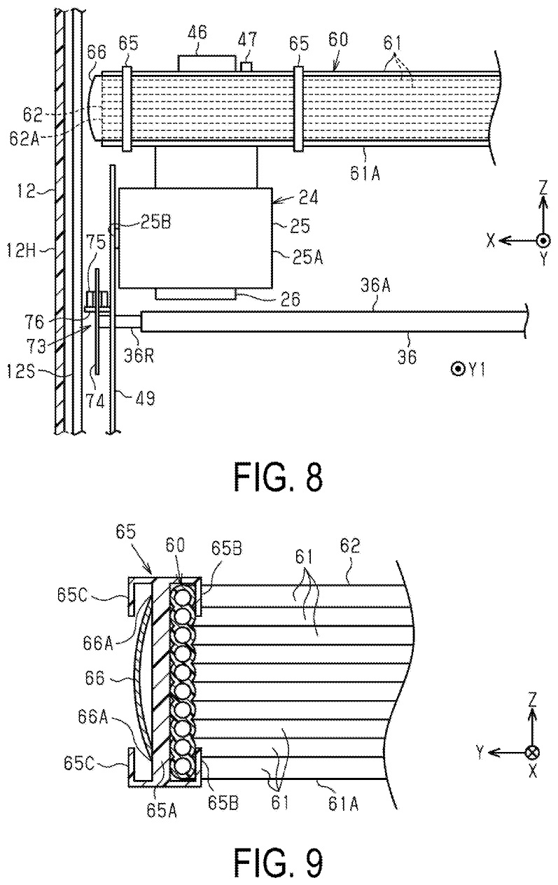

As illustrated in FIG. 7 and FIG. 8, when the recording unit 24 is in the counter-home position AH being the retracting region RA outside the recording region PA in the first direction X1, an edge end 62A of the curved part 62 being the fold back portion of the tube 61 overlaps in position in the X axis with the rotation detector 73.

As illustrated in FIG. 6, when viewed from a direction along the X axis, the rotary scale 74 overlaps with the carriage 25. That is, the rotary scale 74 is located in the first direction X1, from the carriage 25 in the counter-home position AH. Thus, as illustrated in FIG. 7 and FIG. 8, in the embodiment, the rotation detector 73 including the rotary scale 74 determines positions of a side frame 12S and the housing 12H of the recording device 11 in the first direction X1. That is, the rotation detector 73 determines a device size in the direction along the X axis.

Furthermore, as illustrated in FIG. 7, when viewed from the direction along the Z axis, the edge end of the curved part 62 being the fold back portion of the plurality of tubes 61 overlaps with the rotation detector 73. In the example, the movable unit 61A of the tube 61 is supported by the band-like thin plate 66 disposed along a surface outside the movable unit 61A. When the recording unit 24 is in the counter-home position AH, the edge end of the fold back portion of the band-like thin plate 66 overlaps in position in the X axis with the rotation detector 73.

As illustrated in FIG. 7 and FIG. 8, the side plate frame 49 is provided which is configured to position the carriage 25 into the home position HP by bringing the side plate frame 49 into contact with the stopper 25B provided on the side surface of the carriage 25 when the recording unit 24 is in the counter-home position AH.

The rotation detector 73 is attached to the side plate frame 49. A support shaft 36R of the transport roller 36A is rotatably supported with the support shaft 36R penetrating through the side plate frame 49. A center portion of the rotary scale 74 is fixed to, out of the transport roller 36A, an edge end of the support shaft 36R protruding outward from the side plate frame 49. The sensor 75 configured to detect the rotary scale 74 is located to sandwich the rotary scale 74 in a non-contact state at a periphery of the rotary scale 74. The sensor 75 is attached to a base 76 supported on an outer surface of the side plate frame 49. Thus, when the recording unit 24 is in the home position HP, the rotation detector 73 is located outermost in the first direction X1, out of the recording unit 24, a liquid supply system including the tube bundle 60, and the rotation detector 73. In particular, the base 76 of the rotation detector 73 is located outermost. The metal side frame 12S is located in the first direction X1 from the rotation detector 73, and the housing 12H is located outside of the side frame 12S.

Therefore, a position at which the rotation detector 73 is disposed determines a width size being a size in the X direction of the recording device 11. That is, a position of the rotation detector 73 attached to the side plate frame 49 used as a target against which the stopper 25B stops when the recording unit 24 is in the counter-home position AH determines the width size of the recording device 11. Thus, a position of the housing 12H located at the end of the recording device 11 in the first direction X1 is determined based on the position of the rotation detector 73 attached to the side plate frame 49 in the X direction.

As illustrated in FIG. 7 and FIG. 8, when the recording unit 24 is in the counter-home position AH, the curved part 62 of the tube bundle 60 protrudes from the recording unit 24 in the first direction X1. As illustrated in FIG. 8, when viewed from the downstream toward the upstream in the transport direction Y1, the curved part 62 of the tube bundle 60 is above the rotary scale 74. That is, the curved part 62 and the rotary scale 74 partially overlap in position in the X axis.

As illustrated in FIG. 7 and FIG. 8, within the determined width size, when the recording unit 24 is in the counter-home position AH, an edge end 62A located closest to the first direction X1 in the curved part 62 of the tube bundle 60 overlaps, in position in the X axis, with the rotation detector 73. Note that in the X axis, the edge end 62A of the tube bundle 60 may not overlap with the rotary scale 74 included in the rotation detector 73. When the recording unit 24 is in the counter-home position AH, it may suffice that the edge end 62A of the fold back portion overlaps with an edge end of the rotation detector 73 in the first direction X1. Alternatively, when the recording unit 24 is in the counter-home position AH, it may suffice that the edge end 62A of the fold back portion is located in the second direction X2 from the edge end of the rotation detector 73 in the first direction X1.

Within the width size determined based on the position of the rotation detector 73, a length by which the curved part 62 protrudes from the carriage 25 in the first direction X1 is adjusted. To ensure that the curved part 62 of the tube 61 has a radius of curvature that is greater than or equal to a minimum allowable radius of curvature, the edge end 62A of the curved part 62 protruding from the carriage 25 into the first direction X1 is disposed in a space SA between the carriage 25 and an edge of the base 76 of the rotation detector 73 in the first direction X1. As a result, the tube 61 can be routed while the curved part 62 is prevented from affecting the width size of the recording device 11. Furthermore, within the determined width size, the radius of curvature of the curved part 62 is suppressed while maintaining at the minimum allowable of a radius of curvature or greater without imposing a load on the tube 61.

In the example, the band-like thin plate 66 is disposed outside of the movable unit 61A including the curved part 62 of the tube bundle 60. Thus, when the recording unit 24 is in the counter-home position AH, the edge end in the first direction X1 of the fold back portion curved along the outer peripheral surface of the curved part 62, out of the band-like thin plate 66, overlaps in position in the X axis, with the rotation detector 73. The edge end of the curved part of the band-like thin plate 66 is disposed within the space SA illustrated in FIG. 7. In other words, when the recording unit 24 is in the counter-home position AH, it is sufficient that the edge end of the fold back portion of the band-like thin plate 66 in the first direction X1 is at the same position in the scanning direction X as the edge end of the rotation detector 73 in the first direction X1, or is in the second direction X2, relative to the scanning direction X, from the edge end of the rotation detector 73.

As illustrated in FIG. 9, the clamp member 65 is interposed between the tube 61 and the band-like thin plate 66 and has a function of preventing contact between the tube 61 and the band-like thin plate 66. Specifically, the clamp member 65 includes a quadrangular plate-like partition wall portion 65A, a pair of upper and lower first holding units 65B extending toward one side in a thickness direction of the partition wall portion 65A and having an L shape in cross section, and a pair of upper and lower second holding units 65C extending toward the other side in the thickness direction of the partition wall portion 65A and having an L shape in cross section. The band-like tube bundle 60 is held by the pair of first holding units 65B on the clamp member 65, and the band-like thin plate 66 is held by the pair of second holding units 65C on the clamp member 65. As a result of the partition wall portion 65A being interposed between the band-like tube bundle 60 and the band-like thin plate 66, the tube 61 and the band-like thin plate 66 are held at intervals across a longitudinal direction of the tube 61.

In addition, when the partition wall portion 65A of the clamp member 65 is sandwiched between the tube 61 and the band-like thin plate 66, it is possible to prevent contact between the end surface of the band-like thin plate 66 and the tube 61. This prevents a case where the end surfaces 66A on both sides in the width direction of the band-like thin plate 66 made of metal from coming into contact with the tube 61 to damage the tube 61. Additionally, the width dimension being a dimension of the band-like thin plate 66 in the Z direction is shorter than the width dimension of the tube bundle 60. Therefore, a structure can be achieved where even if the band-like thin plate 66 and the tube bundle 60 come close to each other in a portion without the clamp member 65 in the curved part 62, the end surface 66A of the band-like thin plate 66 is less likely to contact the tube bundle 60.

The band-like thin plate 66 is a thin plate made of metal having a thickness ranging from 0.1 to 0.2 mm. Compared to a band-like thin plate made of synthetic resin, the band-like thin plate 66 made of metal provides a strong force by which it is possible to suppress the tube 61 from expanding outwardly because of a high rigidity. As a result, the radius of curvature in the curved part 62 of the tube 61 is reduced. Thus, the tube movement region TA can be shortened in the transport direction Y1.

Thus, an outermost position of the tube 61 can be disposed inwardly in the X axis. That is, because of the high rigidity of the band-like thin plate 66 made of metal, the radius of curvature of the curved part 62 is smaller than the case where the band-like thin plate made of synthetic resin is employed. A movable portion of the tube bundle 60 is held by the band-like thin plate 66 made of metal extending along the longitudinal direction at a path passing through an outer side of the curved part 62, and thus, the radius of curvature of the curved part 62 of the tube 61 can be reduced. When the recording unit 24 is in the counter-home position AH, the radius of curvature of the curved part 62 is reduced, and the length by which the curved part 62 of the tube 61 protrudes outwardly of the carriage 25 is reduced.

A cross section of the band-like thin plate 66 obtained when the band-like thin plate 66 is cut in a direction intersecting a direction in which the band-like thin plate 66 extends has a curved shape in which a center portion of the band-like thin plate 66 in the width direction expands into a direction away from the tube 61. The band-like thin plate 66 is made of metal and has a higher rigidity than a band-like thin plate made of synthetic resin, and in addition, has the above-described curved shape in cross section, and thus, a high rigidity in the longitudinal direction is imparted to provide a higher effect to prevent sagging of the tube bundle 60. For example, when the recording unit 24 is in the home position HP, the curved part 62 is away from the recording unit 24, and as a result, the tube bundle 60 is likely to sag due to its weight, however, the tube bundle 60 is supported by the band-like thin plate 66 being made of metal and having a curved shape in cross section, and thus, sagging of the tube bundle 60 is suppressed.

Next, an electrical configuration of the recording device 11 will be described with reference to FIG. 10. As illustrated in FIG. 10, the recording device 11 includes a control unit 80. The control unit 80 performs various controls including recording control for the recording device 11. The control unit 80 is electrically coupled with the medium detector 38, the rotation detector 73, and the linear encoder 56, which serve as an input system. The medium detector 38 detects presence or absence of the medium M, and outputs a detection signal to the control unit 80. The control unit 80 detects a front end of the medium M when the medium detector 38 is switched from a non-detection state where the medium detector 38 does not detect the medium M to a detection state where the medium detector 38 detects the medium M, based on the detection signal. The control unit 80 detects a rear end of the medium M when the medium detector 38 is switched from the detection state where the medium detector 38 detects the medium M to the non-detection state where the medium detector 38 does not detect the medium M, based on the detection signal.

The rotation detector 73 includes a rotary encoder. The rotation detector 73 outputs a detection signal including a number of pulses proportional to an amount of rotation of the transport roller pair 36. The linear encoder 56 includes a linear scale (not illustrated) and a sensor provided on the carriage 25, and outputs a detection signal including a number of pulses proportional to an amount of movement of the recording unit 24 when the sensor optically reads the linear scale.

As illustrated in FIG. 10, the control unit 80 is electrically coupled with the feeding motor 81, a transport motor 82, the carriage motor 53, the recording head 26, and the gap adjustment mechanism 57, which serve as an output system. The control unit 80 controls the feeding motor 81, the transport motor 82, the carriage motor 53, the recording head 26, and the gap adjustment mechanism 57.

As illustrated in FIG. 10, the control unit 80 includes a first counter 91 and a second counter 92. The first counter 91 counts a value corresponding to a position of the front end or the rear end of the medium M. When the medium detector 38 detects the front end or the rear end of the medium M, the first counter 91 is reset. The first counter 91 counts pulse edges of the detection signal input from the rotation detector 73 configured to detect rotation of the transfer roller 36A (see FIG. 4). Thus, a count value of the first counter 91 indicates the position of the front end or the rear end of the medium M in the transport direction Y1 where the position to be detected by the medium detector 38 is an origin. The control unit 80 controls transport of the medium M by controlling the transport system motors 81 and 82, based on the count value of the first counter 91.

The second counter 92 counts a value corresponding to the location of the carriage 25. When the carriage 25 reaches an origin position such as the home position HP, the second counter 92 is reset. The second counter 92 counts the pulse edges of the detection signal input from the linear encoder 56. Thus, a count value of the second counter 92 indicates the position of the carriage in the X direction where the home position HP of the carriage 25 is an origin. The control unit 80 controls movement of the recording unit 24 by controlling the carriage motor 53, based on the count value of the second counter 92.

Next, an operation of the recording device 11 will be described.

When a user operates a pointing device such as a keyboard and a mouse (not illustrated) of the host device 100, recorded data PD is transmitted from the host device 100 to the recording device 11.

The control unit 80 drives the feeding motor 81 and the transport motor 82, based on the received recorded data PD, to feed the medium M and transport the medium M to a printing start position. Next, when a recording operation in which the recording unit 24 makes one movement in the first direction X1, and during the one movement, the recording head 26 ejects liquid from the nozzles 27 to perform one pass of recording on the medium M, and a transport operation in which the transport roller pair 36 and the discharge roller pair 37 transport the medium M to a next recording position, are performed alternately, an image and the like are recorded on the medium M. When the recording onto the medium M is ended, the recorded medium M is discharged by the transport roller pair 36 and the discharge roller pair 37, and is placed on the discharge tray 19.

When the medium detector 38 detects the medium M, the first counter 91 is reset. The control unit 80 drives the transport motor 82 to transport the medium M to a transport position. The first counter 91 counts pulse edges of a detection pulse signal input from the rotation detector 73. The control unit 80 stops the transport motor 82 when the first counter 91 reaches a target transport position. As a result, the medium M is transported to the target transport position.

The recording unit 24 reciprocates in the first direction X1 and the second direction X2. During the recording operation in which the recording unit 24 makes one movement, when the recording head 26 ejects liquid droplets from the nozzles 27, one pass of recording is performed.

When the recording unit 24 is in the home position HP, the position of the edge of the carriage 25 in the second direction X2 is a factor for determining the width dimension of the recording device 11. When the recording unit 24 is in the counter-home position AH, the position of the edge of the base 76 of the rotation detector 73 in the first direction X1 assembled on an outer surface of the side plate frame 49 against which the edge of the carriage 25 in the first direction X abuts is a factor for determining the width dimension of the recording device 11.

That is, the length by which the curved part 62 protrudes from the carriage 25 into the first direction X1 is adjusted within the determined size. Thus, when the curved part 62 protruding from the carriage 25 is contained in the space SA (see FIG. 7) between the carriage 25 and the edge of the base 76 of the rotation detector 73 in order to secure the minimum allowable radius of curvature of the tube 61, the tube 61 can be routed without unnecessarily increasing the width size of the recording device 11.

Thus, as described in detail, according to above-described embodiment, the following advantages are achieved.

(1) The recording device 11 includes the transport unit 32, the recording unit 24, the mounting portion 29 provided downstream of the recording unit 24 in the transport direction Y1, and the tube 61 including the movable end 61M coupled to the recording unit 24 and the fixed end 61F being fixed at a predetermined position and communicating with the mounting portion 29. The liquid accommodator 28 configured to accommodate liquid supplied to the recording unit 24 is mounting in the mounting portion 29. The tube 61 extends from the movable end 61M into the first direction X1 being one direction along the scanning direction X, is folded back in the second direction X2 being a direction opposite to the first direction X1, and extends to the fixed end 61F. The recording unit 24 is movable in the scanning direction X to the recording region PA where the recording is performed on the medium M and to the retracting region RA outside the recording region PA in the first direction X1. The transport unit 32 includes the transport roller 36A configured to rotate to impart a transport force to the medium M, and the rotation detector 73 configured to detect rotation of the transport roller 36A. The rotation detector 73 includes a rotary scale 74 attached to an edge end of the transport roller 36A in the first direction X1, and a sensor 75 configured to detect the rotation of the transport roller 36A where the rotary scale 74 is to be detected. When the recording unit 24 is in the retracting region RA in the first direction X1, the edge end 62A of the curved part 62 being the fold back portion of the tube 61 overlaps, in position in the scanning direction X, with the rotation detector 73.

Thus, when the recording unit 24 is in the retracting region RA outside the recording region PA in the first direction X1, even if the curved part 62 of the tube 61 protrudes from the carriage 25 in the first direction X1, when the edge end 62A of the curved part 62 overlaps in position with the rotation detector 73 in the scanning direction X, a device size in the scanning direction X is determined based on a position where the rotation detector 73 is disposed. Moreover, within the determined device size, the radius of curvature of the curved part 62 can be set to be equal to or more than a minimum allowable radius of curvature by which a load is imposed on the tube 61. In addition, the edge end 62A of the curved part 62 is set to have a large curvature within a range not exceeding the rotation detector 73 in the first direction X1, and thus, the device size in the transport direction Y1 is reduced. As a result, it is possible to reduce the device size in both the scanning direction X and the transport direction Y1 while suppressing the load on the tube 61.

(2) In the transport direction Y1, the center portion of the carriage 25 is between the first coupling position P1, which is the position of the movable end 61M where the tube 61 is coupled to the carriage 25, and the second coupling position P2, which is the position of the fixed end 61F of the tube 61. Thus, it is possible to increase the radius of curvature of the fold back portion of the tube 61 while reducing the device size in the transport direction Y1. Thus, as compared to a configuration in which the movable end 61M and the fixed end 61F of the tube 61 do not sandwich the center portion of the carriage 25, it is possible to further reduce the device size and alleviate the load on the tube 61.

(3) The control board 70 configured to control the recording head 26 is provided at a position opposite the mounting portion 29 with respect to the movement path of the carriage 25 in the transport direction Y1. The cable 71 coupling the recording head 26 and the control board 70 extends in the second direction X2 from the recording unit 24 and is coupled to the control board 70 after being folded back in the first direction X1. Thus, when the direction (second direction X2) in which the cable 71 extends is configured to be opposite to the direction (first direction X1) in which the tube 61 extends, with respect to the recording unit 24, it is possible to prevent interference between the cable 71 and the tube 61.

(4) The third coupling position P3 being the position where the cable 71 is coupled to the carriage 2 is located on the same side as the first coupling position P1 with respect to the center portion of the carriage 25 in the transport direction Y1. Thus, when the recording unit 24 is in the retracting region RA in the second direction X2, the load is less likely to be applied to the third coupling position P3.

(5) The recording device 11 includes the band-like thin plate 66 made of metal configured to support the movable unit 61A used to form the fold back portion of the tube 61. Thus, as compared to a configuration in which the movable unit 61A is supported by a band-like thin plate made of synthetic resin, when the recording unit 24 is in the retracting region RA (home position HP) in the second direction X2, sagging of the fold back portion of the tube 61 can be suppressed. Even if the recording unit 24 is in the home position HP for a long time, the sagging tendency of the tube 61 and the band-like thin plate 66 is prevented. Further, compared to a configuration in which a band-like think plate made of synthetic resin is employed, the fold back portion of the tube 61 can be supported with a greater curvature, and thus, it is possible to further reduce the device size in the scanning direction X and the transport direction Y1.

(6) The recording device 11 includes the clamp member 65 configured to clamp the band-like thin plate 66 and the tube 61 which are spaced apart. Thus, it is possible to avoid direct contact between the tube 61 and the band-like thin plate 66 made of metal. Therefore, it is possible to avoid the tube 61 from being damaged as a result of the edge of the band-like thin plate 66 made of metal and the like contacting the tube 61.

(7) The face 41A of the front frame 41 on which the fixed end 61F of the tube 61 is supported is provided with the abutting portion 67 at a site against which the band-like thin plate 66 abuts and the clamp member 65 does not abut. Thus, in a process of the recording unit 24 moving in the second direction X2, the band-like thin plate 66 abuts against the abutting portion 67 and the clamp member 65 enters a recessed portion without the abutting portion 67, and thus, the band-like thin plate 66 can be supported on the abutment surface 67A and the collision of the clamp member 65 with the front frame 41 can be avoided. Thus, vibration of the tube 61 can be suppressed.

Note that the above-described embodiment may be modified as the following modification. Furthermore, the above-described embodiment and the modification described below may be appropriately combined to provide a further modification, or appropriate combinations of the following modifications may be used as a further modification.

A direction in which the plurality of tubes 61 extending from the carriage 25 are routed may be orthogonal to the direction in the above-described embodiment. For example, as illustrated in FIG. 11, the plurality of tubes 61 extending in the first direction X1 from the movable end 61M coupled to the second joint member 47 extend in the second direction X2 after being curved so as to be folded back while displacing in the Z direction. The tube bundle 60 is arranged in an orientation so that the arraying direction in which the plurality of tubes 61 are arrayed is the transport direction Y1. The plurality of tubes 61 are supported by the band-like thin plate 66 made of metal, and the plurality of tubes 61 and the band-like thin plate 66 are clamped by the clamp member 65 at a plurality of locations at intervals in the longitudinal direction. The clamp member 65 has a similar configuration to that of the above-described embodiment, and clamps the plurality of tubes 61 and the band-like thin plate 66 which are spaced apart. The curved part 62 protrudes in the first direction X1 from the carriage 25, and the protruding portion of the curved part 62 is disposed within the space between the edge on the outside of the base 76 included in the rotation detector 73 and the carriage 25 in the counter-home position AH. That is, when the recording unit 24 is in the retracting region outside the recording region in the first direction X1, the edge end 62A of the curved part 62 located outermost in the first direction X1 overlaps, in position in the scanning direction X, with the rotation detector 73. In particular, in the configuration illustrated in FIG. 11 in which the band-like thin plate 66 supports the tube bundle 60, the edge end of the curved part of the band-like thin plate 66 overlaps, in position in the scanning direction X, with the rotation detector 73.

In the embodiment and the modification of FIG. 11, the configuration is that the curved part 62 is at a side of the counter-home position AH where the rotation detector 73 is disposed; however, configuration may be that for example, the rotation detector 73 is disposed at a side of the home position HP in the chassis 12 and the curved part 62 is at a side of the home position HP. In this case, the first direction X1 and the second direction X2 are opposite of the first direction X1 and the second direction X2 in FIG. 6 to FIG. 8 and FIG. 11. In these configurations, an effect equivalent to that of the embodiment described above can be obtained, and when the recording unit 24 is in the home position HP, the curved part 62 is near the recording unit 24, and thus, it is possible to decrease a risk of sagging of the tube bundle 60 due to its weight.

In FIG. 6, in a side view viewed from the scanning direction X, the carriage 25 and the rotary scale 74 overlap, but may not overlap.

The abutting portion 67 may have a thickness allowing the clamp member 65 to contact the face 41A of the front frame 41. In this configuration as well, the impact generated when the clamp member 65 collides with the face 41A can be mitigated. Thus, vibration of the tube 61 can be suppressed.

A gear may be provided on the support shaft 36R of the transport roller 36A. For example, configuration may be that the rotation of the transport roller 36A is transmitted to the discharge roller 37A via a gear train including a gear provided on the support shaft 36R of the transport roller 36A and a gear provided on the support shaft of the discharge roller 37A. The gear is provided on the support shaft 36R at a position between the rotary scale 74 and the side plate frame 49. Note that the gear may be provided in the first direction X1 from the rotary scale 74 on the support shaft 36R.

The rotation detector 73 is not limited to an incremental type, and may be an absolute type.

The cross-sectional shape of the band-like thin plate 66 is not limited to a shape expanding outwardly in a cross section orthogonal to a longitudinal direction.

The band-like thin plate 66 may be made of synthetic resin instead of metal. Additionally, the band-like thin plate 66 may be eliminated.

The support tube 46 is provided to protrude on the upper side of the carriage 25, but a support plate may be provided instead of the support tube 46. In short, it may suffice that the support tube 46 is a protruding portion provided to protrude on the carriage 25 to hold the movable end 61M of the plurality of tubes 61 along with the straight-line part 61B. Additionally, the protruding portion may have a slit capable of clamping the plurality of tubes 61. It is preferable that the protruding portion is provided at a location where the first coupling position P1 and the second coupling position P2 can be positioned while the center portion of the carriage 25 being therebetween in the transport direction Y1.

The medium M is not limited to a sheet, and may be a synthetic resin film, a sheet, a cloth, a nonwoven fabric, a laminate sheet, and the like.

The recording device 11 is not limited to an ink-jet type printer, and may be an ink-jet type printing apparatus. The recording device 11 may also be a multifunction device including a scanner function and a copy function in addition to a printing function.

In the above-described embodiment, the scanning direction is the direction along the X axis, the transport direction Y1 is the direction along the Y axis, and the direction is the direction along the Z axis, but the scanning direction and the transport direction Y1 are not limited to being mutually orthogonal, and the scanning direction and the arraying direction are not limited to being mutually orthogonal. The transport direction Y1 may be a direction intersecting the scanning direction. Additionally, the arraying direction may be a direction intersecting two directions, that is, the scanning direction and the transport direction Y1. Furthermore, in FIG. 11, the arraying direction of the plurality of tubes 61 is not limited to a direction in which the plurality of tubes 61 are arrayed horizontally to the transport direction Y1, and may be direction in which the plurality of tubes 61 are arrayed to be inclined obliquely with respect to the transport direction Y1 so that the positions of the tubes 61 in the Z direction are slightly shifted from one another.

The rotation detector 73 may not be of optical type. For example, a circular plate formed thereon with a plurality of magnetic poles, in place of a plurality of slits, may be employed for the rotary scale 74. In this case, it is preferable that the sensor 75 employ a magnetic sensor such as a magnetic rotary encoder. That is, the rotation detector 73 may be of magnetic type. In this case, the rotary scale 74 may not be necessarily sandwiched between the light-emitting unit and the light-receiving unit. Accordingly, it is possible to employ a structure in which the edge end of the sensor 75 in the first direction X1 is disposed in the second direction X2 with respect to the rotary scale 74. In this case, the width dimension of the recording device 11 is determined based on the position of the rotary scale 74 in the X axis. Thus, it may suffice that when the recording unit 24 is in the counter-home position AH, the edge end 62A of the fold back portion overlaps with the edge of the rotary scale 74 in the first direction X1. Alternatively, it may suffice that when the recording unit 24 is in the counter-home position AH, the edge end 62A of the fold back portion is located in the second direction X2 from the edge end of the rotary scale 74 in the first direction X1.

Contents derived from the above-described embodiment and modification are described below.

A recording device includes a recording unit including a recording head configured to eject liquid onto a medium to perform recording thereon, and a carriage configured to support the recording head and move in a first direction and a second direction which is an opposite direction to the first direction, a transport unit configured to transport the medium in a transport direction intersecting the first direction or the second direction, an mounting portion that is provided downstream of the recording unit in the transport direction and to which a liquid accommodating unit, in which the liquid to be supplied to the recording unit is accommodated, is mounted, and at least one tube having flexibility and including a fixed end fixed at a position downstream of the mounting portion in a liquid supply direction and a movable end configured to move relative to the fixed end in the scanning direction, the movable end being coupled to the recording unit, in which the at least one tube extends from the movable end in the first direction and extends to the fixed end after being folded back in the second direction, the recording unit is configured to move to a recording region where recording onto the medium is performed and to a retracting region that is outside the recording region in the first direction, the transport unit includes a transport roller configured to rotate to impart a transport force to the medium, and a rotation detector including a rotary scale attached to an edge end of the transport roller in the first direction, and a sensor configured to detect rotation of the transport roller with the rotary scale serving as a detection object, and when the recording unit is in the retracting region, an edge end of a fold back portion of the at least one tube overlaps, at a position in the first direction, the rotation detector.

According to this configuration, when the recording unit is in the retracting region, even if the fold back portion of at least one tube protrudes from the carriage in the first direction, when the edge end of the fold back portion is configured to overlap, in position in the scanning direction, with the rotation detector, the device size in the scanning direction is determined based on a position where the rotation detector is displaced. Moreover, within the device size, the radius of curvature of the fold back portion can be set to be equal to or more than a minimum allowable radius of curvature by which a load is not imposed on the tube. Furthermore, the edge end of the fold back portion is set to have a large curvature within a range not exceeding the rotation detector in the first direction, and thus, the device size in the transport direction is reduced. As a result, it is possible to reduce the device size in both the scanning direction and the transport direction while suppressing the load on at least one tube.

In the recording device described above, a center portion of the carriage may be located, in the transport direction, between a first coupling position, which is a position of the movable end where the at least one tube is coupled to the carriage, and a second coupling position, which is a position of the fixed end of the at least one tube.

According to this configuration, it is possible to increase the radius of curvature of the fold back portion of the at least one tube while reducing the device size in the direction along the transport direction. Thus, as compared to a case where the movable end and the fixed end of the tube do not sandwich the center portion of the carriage, it is possible to reduce the device size and alleviate the load on the tube.

The recording device may include a control board configured to control the recording head, and a cable configured to couple the recording head and the control board, wherein in the transport direction, the control board may be provided on an opposite side of a movement path of the carriage from the mounting portion, and the cable may extend from the recording unit in the second direction and may be coupled to the control board after being folded back in the first direction.

According to this configuration, when the direction in which the cable extends is configured to be opposite to the direction in which the tube extends, with respect to the recording unit, it is possible to prevent interference between the cable and the tube.

In the recording device, a third coupling position, which is a position where the cable is coupled to the carriage, is located at as same side of a center portion of the carriage as the first coupling position in the transport direction.

According to this configuration, when the recording unit is in the retracting region in the second direction, the load is less likely to be applied to the third coupling position of the cable.

The recording device may include a band-like thin plate made of metal, the band-like thin plate being configured to support a movable unit used to form the fold back portion of the at least one tube.

According to this configuration, as compared to a configuration where the movable unit is supported by a band-like thin plate made of synthetic resin, when the recording unit is in the retracting region outside the recording region in the second direction, it is possible to prevent sagging of the fold back portion of the tube.

The recording device may include a clamp member configured to clamp the band-like thin plate and the at least one tube, which are in a state of being spaced apart.

According to this configuration, it is possible to avoid direct contact between the tube and the band-like thin plate made of metal. Thus, it is possible to avoid a case where the edge and the like of the band-like thin plate made of metal contact the tube to damage the tube.

The recording device described above may include a support portion including a face which intersects the transport direction and in which the fixed end of the at least one tube is supported, and extending in the scanning direction, in which the face of the support portion may be provided with an abutting portion at a site against which the band-like thin plate abuts and the claim member does not abut.

According to this configuration, in a process in which the recording unit moves in the second direction, the band-like thin plate abuts against the abutting portion, the clamp member enters a recessed portion without the abutting portion, and the collision of the clamp member with the support portion can be avoided. Thus, vibration of the tube can be suppressed.

What is claimed is:

1. A recording device, comprising:
a recording unit including a recording head configured to eject liquid onto a medium to perform recording thereon and a carriage configured to support the recording head and move in a first direction and a second direction which is an opposite direction to the first direction;
a transport unit configured to transport the medium in a transport direction intersecting the first direction or the second direction;
a mounting portion that is provided downstream of the recording unit in the transport direction and to which a liquid accommodating unit, in which the liquid to be supplied to the recording unit is accommodated, is mounted; and
at least one tube having flexibility and including a fixed end fixed at a position downstream of the mounting portion in a liquid supply direction and a movable end configured to move relative to the fixed end in the scanning direction, the movable end being coupled to the recording unit, wherein
the at least one tube extends from the movable end in the first direction and extends to the fixed end after being folded back in the second direction,
the recording unit is configured to move to a recording region where recording onto the medium is performed and to a retracting region that is outside the recording region in the first direction,
the transport unit includes:
a transport roller configured to rotate to impart a transport force to the medium; and
a rotation detector including a rotary scale attached to an edge end of the transport roller in the first direction, and a sensor configured to detect rotation of the transport roller with the rotary scale serving as a detection object, and
when the recording unit is in the retracting region, an edge end of a fold-back portion of the at least one tube overlaps, at a position in the first direction, the rotation detector.

2. The recording device according to claim 1, wherein a center portion of the carriage is located, in the transport direction, between a first coupling position, which is a position of the movable end where the at least one tube is coupled to the carriage, and a second coupling position, which is a position of the fixed end of the at least one tube.

3. The recording device according to claim 2, comprising:
a control board configured to control the recording head; and
a cable configured to couple the recording head and the control board, wherein
in the transport direction, the control board is provided on an opposite side of a movement path of the carriage from the mounting portion, and
the cable extends from the recording unit in the second direction and is coupled to the control board after being folded back in the first direction.

4. The recording device according to claim 3, wherein
a third coupling position, which is a position where the cable is coupled to the carriage, is located at a same side of a center portion of the carriage as the first coupling position in the transport direction.

5. The recording device according to claim 1, comprising a band-like thin plate made of metal, the band-like thin plate being configured to support a movable unit used to form a fold back portion of the at least one tube.

6. The recording device according to claim 5, comprising a clamp member configured to clamp the band-like thin plate and the at least one tube, which are in a state of being spaced apart.

7. The recording device according to claim 6, comprising a support portion including a face that intersects the transport direction and at which the fixed end of the at least one tube is supported, and extending in the scanning direction, wherein
the face of the support portion is provided with an abutting portion at a site against which the band-like thin plate abuts and the claim member does not abut.
